(19) United States
(12) Patent Application Publication
(10) Pub. No.: US 2026/0022836 A1
(43) Pub. Date: Jan. 22, 2026

(54) COMBUSTOR FOR A GAS TURBINE ENGINE

(71) Applicant: General Electric Company, Evendale, OH (US)

(72) Inventors: Rimple Rangrej, Raipur (IN); Ranganatha Narasimha Chiranthan, Bengaluru (IN); Pradeep Naik, Bengaluru (IN); Saket Singh, Bengaluru (IN); Prithiviraaj Pet T., Madurai (IN); Krishnendu Chakraborty, Kolkata (IN)

(21) Appl. No.: 19/027,130

(22) Filed: Jan. 17, 2025

(30) Foreign Application Priority Data
Jul. 18, 2024 (IN) 202411054940

(51) Int. Cl. F23R 3/00; F23R 3/10

(52) U.S. Cl. CPC F23R 3/002; F23R 3/06

(57) ABSTRACT

A combustor for a gas turbine includes an outer casing, an inner casing, and an outer liner and an inner liner defining a combustion chamber. At least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings.

### CROSS REFERENCE TO RELATED APPLICATIONS

The present application claims the benefit of Indian Patent Application number 202411054940, filed on Jul. 18, 2024, which is hereby incorporated by reference herein in its entirety.

### TECHNICAL FIELD

The present disclosure relates to a combustor for a gas turbine engine.

### BACKGROUND

In gas turbine engines, a combustor includes a combustor liner that defines a combustion chamber. The combustor liner may include dilution openings that provide a flow of dilution air into a combustion chamber. The dilution air acts to quench hot combustion gases within the combustion chamber before the hot combustion gases flow into a turbine section of the gas turbine engine.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic cross-sectional side view of an exemplary high by-pass turbofan jet engine, according to an aspect of the present disclosure.

FIG. 2 is a cross-sectional side view of an exemplary combustor, according to an aspect of the present disclosure.

FIG. 3 is a flattened plan view of a cold surface side of a portion of an outer liner, taken at view A-A of FIG. 2, depicting an arrangement of primary dilution openings and secondary wake suppression dilution openings through the outer liner, according to an aspect of the present disclosure.

FIG. 4 is an enlarged flattened plan view of a portion of FIG. 3, taken at detail view 128 of FIG. 3, depicting a dilution airflow pattern according to an aspect of the present disclosure.

FIG. 5 is a cross-sectional view taken at plane 5-5 of FIG. 4, according to an aspect of the present disclosure.

FIG. 6 depicts a flattened plan view of a hot surface side of the portion of the outer liner of FIG. 5, taken at view 6-6 of FIG. 5, depicting an arrangement of primary dilution openings and secondary wake suppression dilution openings through the outer liner, according to an aspect of the present disclosure.

FIG. 7 is a cross-sectional view taken at plane 7-7 of FIG. 5, through the outer liner and a wake flow suppressor of FIG. 5, according to an aspect of the present disclosure.

FIG. 8 is a cross-sectional view of an alternate arrangement of a wake flow suppressor to that of FIG. 5, according to an aspect of the present disclosure.

FIG. 9 is a cross-sectional view of an alternate arrangement of the wake flow suppressor to that of FIG. 8, according to an aspect of the present disclosure.

FIG. 10 is a flattened plan view of a portion of an alternate arrangement to that of FIG. 4 of primary dilution openings and secondary wake suppression dilution openings, according to an aspect of the present disclosure.

FIG. 11 is a cross-sectional view of the alternate arrangement of FIG. 10, taken at plane 11-11 of FIG. 10, according to an aspect of the present disclosure.

FIG. 12 is a flattened plan view of a cold surface side of an alternate arrangement of the portion of an outer liner of FIG. 3, according to an aspect of the present disclosure.

FIG. 13 is a flattened plan view of a cold surface side of the outer liner depicting an alternate arrangement to that of FIG. 3, according to an aspect of the present disclosure.

FIG. 14 is a flattened plan view of a cold surface side of the outer liner depicting an alternate arrangement to that of FIG. 3, according to an aspect of the present disclosure.

FIG. 15 is a flattened plan view of a cold surface side of the outer liner depicting an alternate arrangement to that of FIG. 3, according to an aspect of the present disclosure.

FIG. 16 is a flattened plan view of a cold surface side of the outer liner depicting an alternate arrangement to that of FIG. 3, according to an aspect of the present disclosure.

FIG. 17 is a flattened plan view of a cold surface side of the outer liner depicting an alternate arrangement to that of FIG. 3, according to an aspect of the present disclosure.

FIG. 18 is a flattened plan view of a cold surface side of the outer liner depicting an alternate arrangement to that of FIG. 3, according to an aspect of the present disclosure.

FIG. 19 is a flattened plan view of a cold surface side of the outer liner depicting another alternate arrangement to that of FIG. 3, according to an aspect of the present disclosure.

FIG. 20 is a flattened plan view of a cold surface side of the outer liner depicting another alternate arrangement to that of FIG. 3, according to an aspect of the present disclosure.

FIG. 21 is a flattened plan view of a cold surface side of the outer liner depicting another alternate arrangement to that of FIG. 3, according to an aspect of the present disclosure.

FIG. 22 is a cross-sectional view taken at plane 22-22 of FIG. 21, according to an aspect of the present disclosure.

FIG. 23 is a flattened plan view of a cold surface side of the outer liner depicting another alternate arrangement to that of FIG. 21, according to an aspect of the present disclosure.

FIG. 24 is a flattened plan view of a cold surface side of the outer liner depicting another alternate arrangement to that of FIG. 3, according to an aspect of the present disclosure.

### DETAILED DESCRIPTION

Features, advantages, and embodiments of the present disclosure are set forth or apparent from a consideration of the following detailed description, drawings, and claims. Moreover, it is to be understood that the following detailed description is exemplary and intended to provide further explanation without limiting the disclosure as claimed.

Various embodiments are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

In a combustion section of a turbine engine, airflow in an outer passage surrounding a combustor liner is diverted through circular dilution openings in the combustor liner and into a combustion chamber to be used as dilution air. One purpose of the dilution air is to quench (i.e., to cool) combustion gases within the combustion chamber before the combustion gases enter a turbine section downstream of the combustion chamber. At the trailing edge of the circular dilution opening, along the inner surface of the liner (i.e., inside the combustion chamber), a wake forms in the dilution airflow behind the dilution opening. The wake results in a higher temperature behind the dilution airflow, which causes higher nitrous oxide (NOx) formation in the combustion gases, and which reduces the life of the combustor liner. In addition, the circular dilution opening does not spread the flow of dilution air laterally, thereby, creating high temperatures in-between dilution openings that also contributes to higher NOx formation.

The present disclosure provides a way to suppress the wake region with dilution air and to provide for a better lateral spread of the dilution air within the combustion chamber, thereby reducing the NOx emissions and improving the durability of the liner. According to the present disclosure, the liner includes a plurality of primary dilution openings and a plurality of secondary wake suppression dilution openings. The plurality of secondary wake suppression dilution openings provide a lateral spread of secondary dilution air into the combustion chamber so as to suppress the wake at the downstream side of the primary dilution openings.

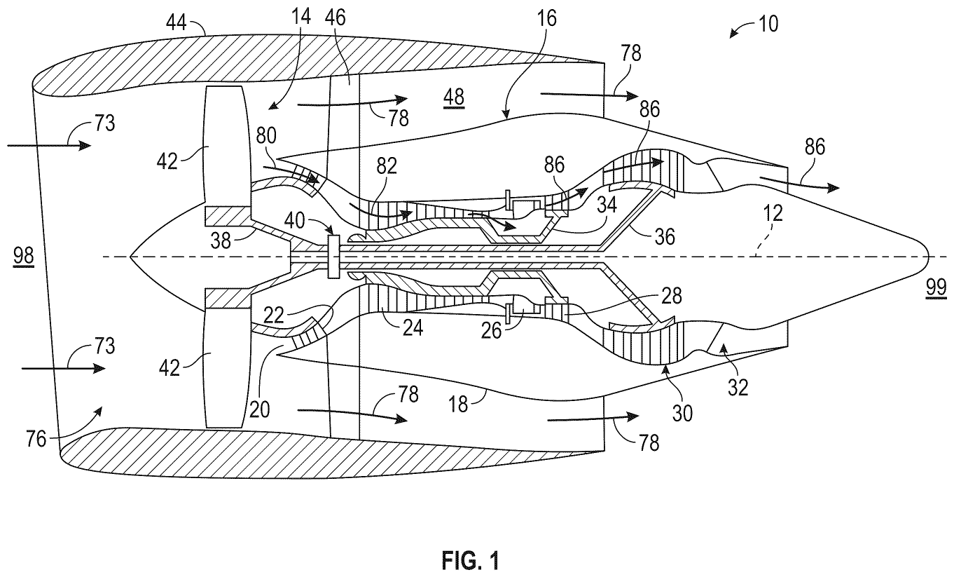

Referring now to the drawings, FIG. 1 is a schematic cross-sectional side view of an exemplary high by-pass turbofan jet engine 10, herein referred to as “engine 10,” as may incorporate various embodiments of the present disclosure. Although further described below with reference to a turbofan engine, the present disclosure is also applicable to turbomachinery in general, including turbojet, turboprop, and turboshaft gas turbine engines, including marine-based turbine engines, industrial turbine engines, and auxiliary power units. As shown in FIG. 1, the engine 10 has a longitudinal centerline axis 12 that extends therethrough from an upstream end 98 of the engine 10 to a downstream end 99 of the engine 10 for reference purposes. In general, the engine 10 may include a fan assembly 14 and a turbo-engine 16 disposed downstream from the fan assembly 14.

The turbo-engine 16 may generally include an outer casing 18 that defines an annular inlet 20 to the turbo-engine 16. The outer casing 18 encases, or at least partially forms, in a serial flow relationship, a compressor section having a low-pressure compressor (LPC) 22 and a high-pressure compressor (HPC) 24, a combustor 26, a turbine section including a high-pressure turbine (HPT) 28 and a low-pressure turbine (LPT) 30, and a jet exhaust nozzle section 32. A high pressure (HP) rotor shaft 34 drivingly connects the HPT 28 to the HPC 24, and a low pressure (LP) rotor shaft 36 drivingly connects the LPT 30 to the LPC 22. The LP rotor shaft 36 may also be connected to a fan shaft 38 of the fan assembly 14. In particular embodiments, as shown in FIG. 1, the LP rotor shaft 36 may be connected to the fan shaft 38 by way of a reduction gearbox assembly 40, such as in an indirect-drive or a geared-drive configuration.

As shown in FIG. 1, the fan assembly 14 includes a plurality of fan blades 42 that are coupled to, and that extend radially outwardly from, the fan shaft 38. An annular fan casing or a nacelle 44 circumferentially surrounds the fan assembly 14 and/or at least a portion of the turbo-engine 16. The nacelle 44 may be supported relative to the turbo-engine 16 by a plurality of circumferentially spaced outlet guide vanes or struts 46. Moreover, at least a portion of the nacelle 44 may extend over an outer portion of the turbo-engine 16 so as to define a bypass airflow passage 48 therebetween.

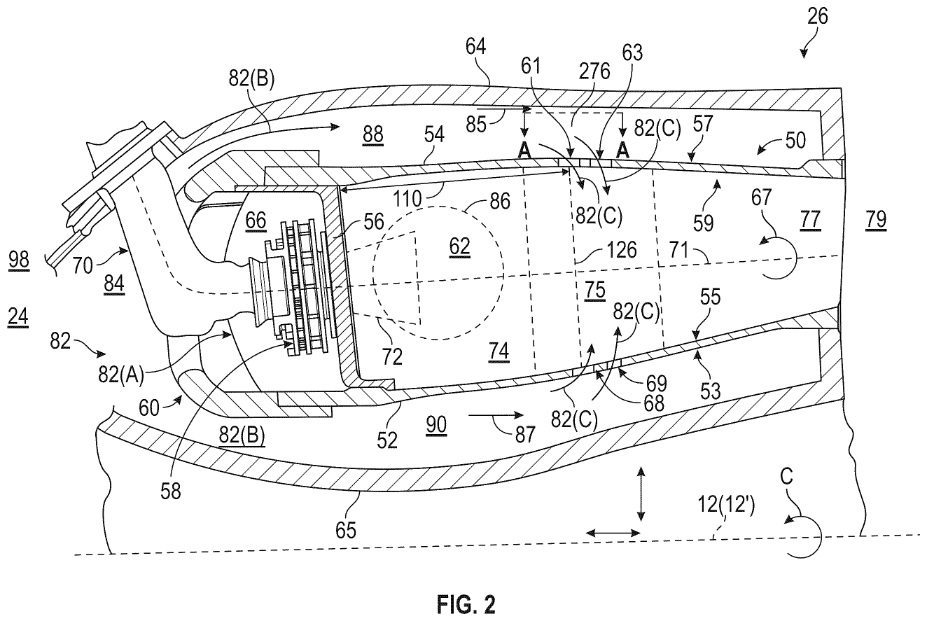

FIG. 2 is a cross-sectional side view of an exemplary combustor 26 of the turbo-engine 16 as shown in FIG. 1. The exemplary combustor 26 shown in FIG. 2 is depicted as an annular-type combustor that extends annularly about the longitudinal centerline axis 12. The longitudinal centerline axis 12 may also correspond to a combustor centerline axis 12′. The present disclosure is not limited to the annular-type combustor 26 of FIG. 2 and can be implemented in other types of combustors, including, as one example, can-type combustors. As shown in FIG. 2, the combustor 26 includes a combustor liner 50 having an inner liner 52 that extends circumferentially about the combustor centerline axis 12′, and an outer liner 54 that extends circumferentially about the combustor centerline axis 12′. A dome assembly 56 is connected to the outer liner 54 and to the inner liner 52, and together, the outer liner 54, the inner liner 52, and the dome assembly 56 define a combustion chamber 62. The inner liner 52, the outer liner 54, and the dome assembly 56 are connected to a cowl 60, and a pressure plenum 66 is defined between the cowl 60, the inner liner 52, the outer liner 54, and the dome assembly 56.

As shown in FIG. 2, the inner liner 52 is encased within an inner casing 65 and the outer liner 54 is encased within an outer casing 64. An outer flow passage 88 is defined between the outer liner 54 and the outer casing 64, and an inner flow passage 90 is defined between the inner liner 52 and the inner casing 65. Both the outer casing 64 and the inner casing 65 extend circumferentially about the combustor centerline axis 12′. A cold surface side 53 of the inner liner 52 is adjacent to the inner flow passage 90, and a hot surface side 55 of the inner liner 52 is adjacent to the combustion chamber 62. Similarly, a cold surface side 57 of the outer liner 54 is adjacent to the outer flow passage 88, and a hot surface side 59 of the outer liner 54 is adjacent to the combustion chamber 62. The inner liner 52 and the outer liner 54 extend from the dome assembly 56 to a turbine nozzle 79 (shown generally) at an entry to the HPT 28 (FIG. 1), thus, at least partially defining a hot gas path between the combustor liner 50 and the HPT 28. As will be described in more detail below, the outer liner 54 includes a plurality of primary dilution openings 61 extending therethrough, and a plurality of secondary wake suppression dilution openings 63 extending therethrough. Similarly, the inner liner 52 includes a plurality of primary dilution openings 68 extending therethrough and a plurality of secondary wake suppression dilution openings 69 extending therethrough.

The combustor 26 also includes a fuel nozzle assembly 70 that is connected to the outer casing 64, and a swirler assembly 58 that is connected to the dome assembly 56. The swirler assembly 58 may define a fuel nozzle centerline axis 71 extending in a generally longitudinal direction within the combustion chamber 62. Fuel is provided by the fuel nozzle assembly 70 to the swirler assembly 58 to mix with air flowing from the pressure plenum 66 through the swirler assembly 58. Thus, a fuel-air mixture 72 is injected into the combustion chamber 62 by the swirler assembly 58. The fuel-air mixture 72 may be injected into the combustion chamber 62 in a swirling manner such that the fuel-air mixture 72 swirls in a swirl direction 67 about the fuel nozzle centerline axis 71, and, after being ignited and burned to generate the combustion gases 86, the combustion gases 86 may swirl within the combustion chamber 62 in the swirl direction 67.

The combustion chamber 62 may, more specifically, define a primary combustion zone 74 at which an initial chemical reaction of the fuel-air mixture 72 occurs when the fuel-air mixture 72 is ignited by an ignitor (not shown) and burned to generate combustion gases 86. The combustion gases 86 may recirculate within the primary combustion zone 74 before the combustion gases 86 flow further downstream to a dilution zone 75. At the dilution zone 75, the combustion gases 86 mix with dilution air 82(C) flowing through the primary dilution openings 61 and through the secondary wake suppression dilution openings 63 of the outer liner 54, and flowing through the primary dilution openings 68 and the secondary wake suppression dilution openings 69 of the inner liner 52, before flowing to a secondary combustion zone 77 and into the turbine nozzle 79 at an entry to the HPT 28 and the LPT 30 (FIG. 1). The flow of the dilution air 82(C) can thus be utilized to provide quenching of the combustion gases 86 in the dilution zone 75 downstream of the primary combustion zone 74 so as to cool the flow of combustion gases 86 entering the HPT 28 (FIG. 1).

Referring collectively to FIG. 1 and to FIG. 2, in operation of the engine 10, a volume of inlet air 73, as indicated schematically by arrows, enters the engine 10 from the upstream end 98 through an associated nacelle inlet 76 of the nacelle 44. The inlet air 73 is propelled by the fan assembly 14 as the inlet air 73 passes across the fan blades 42, and a portion of the inlet air 73 is directed or routed into the bypass airflow passage 48 as a bypass airflow 78. Another portion of the inlet air 73 passing through the fan blades 42 is directed or routed into the annular inlet 20 into the LPC 22 as a compressor inlet air 80. The compressor inlet air 80 is progressively compressed as the inlet air 80 flows through the LPC 22 and the HPC 24 towards the combustor 26, thereby generating compressed air 82. As shown in FIG. 2, compressed air 82 flows from the HPC 24 into a diffuser cavity 84 of the combustor 26. A first portion of the compressed air 82, as indicated schematically by arrows denoting compressed air 82(A), flows from the diffuser cavity 84 into the pressure plenum 66, where the compressed air 82(A) is mixed by the swirler assembly 58 with fuel provided by the fuel nozzle assembly 70 to generate the fuel-air mixture 72. As described above, the fuel-air mixture 72 is ignited and burned to generate the combustion gases 86 within the primary combustion zone 74 of the combustion chamber 62. A second portion of the compressed air 82, as indicated by arrows denoting compressed air 82(B), is routed into the outer flow passage 88 and generally flows in a downstream flow direction 85 within the outer flow passage 88. Similarly, a portion of the compressed air 82(B) may be routed into the inner flow passage 90 and generally flows downstream in a downstream flow direction 87 within the inner flow passage 90. A portion of the compressed air 82(B) within the outer flow passage 88 and within the inner flow passage 90 passing over the primary dilution openings 61, passing over the secondary wake suppression dilution openings 63, passing over the primary dilution openings 68, and passing over the secondary wake suppression dilution openings 69, is used as the dilution air 82(C) and flows into the dilution zone 75 of combustion chamber 62 to provide the quenching of the combustion gases 86 in dilution zone 75. The dilution air 82(C) may also provide turbulence to the flow of the combustion gases 86 so as to provide better mixing of the dilution air 82(C) with the combustion gases 86.

Referring still to FIGS. 1 and 2 collectively, the combustion gases 86 generated in the combustion chamber 62 flow into the HPT 28, thus causing the HP rotor shaft 34 to rotate, thereby supporting operation of the HPC 24. As shown in FIG. 1, the combustion gases 86 are then routed through the LPT 30, thus causing the LP rotor shaft 36 to rotate, thereby supporting operation of the LPC 22 and/or rotation of the fan shaft 38. The combustion gases 86 are then exhausted through the jet exhaust nozzle section 32 of the turbo-engine 16 to provide propulsion at the downstream end 99 of the engine 10.

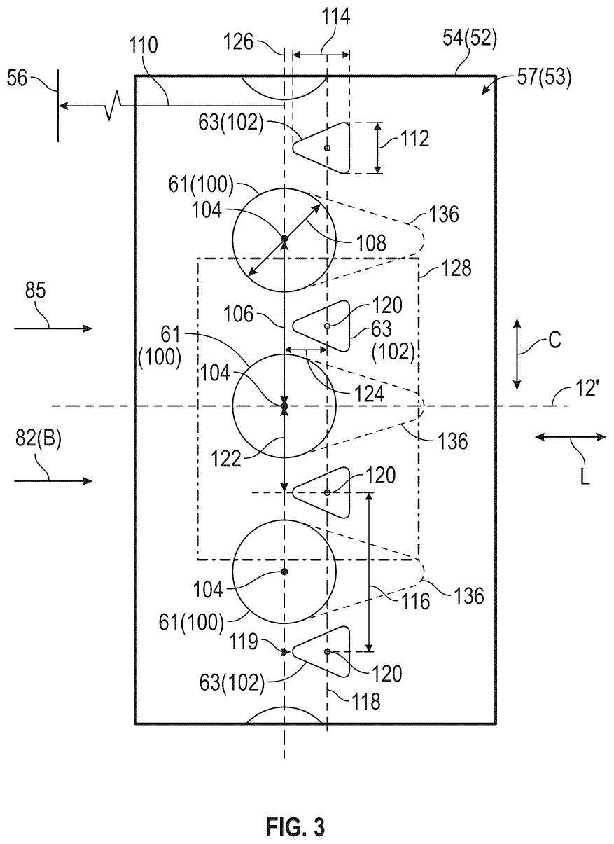

FIG. 3 is a flattened plan view of a cold surface side 57 of a portion of the outer liner 54, taken at view A-A of FIG. 2, depicting an arrangement of the primary dilution openings 61 and the secondary wake suppression dilution openings 63 through the outer liner 54, according to an aspect of the present disclosure. While FIG. 3 is described with regard to the outer liner 54, the arrangement of FIG. 3, as well as alternate arrangements discussed below, are also applicable to the inner liner 52. As shown in FIG. 3, the plurality of primary dilution openings 61 may be circular-shaped dilution openings 100, and the plurality of secondary wake suppression dilution openings 63 may be wedge-shaped dilution openings 102. The plurality of primary dilution openings 61 are circumferentially spaced apart in the circumferential direction (C) with respect to the combustor centerline axis 12′, and the plurality of secondary wake suppression dilution openings 63 are also circumferentially spaced apart in the circumferential direction (C) with respect to the combustor centerline axis 12′. Respective ones of the plurality of primary dilution openings 61 are arranged adjacent to respective ones of the plurality of secondary wake suppression dilution openings 63. Here, the term “adjacent” is intended to mean that the primary dilution openings 61 and the second wake suppression dilution openings 63 are arranged next to one another such that a secondary dilution air 82(C) S flowing through respective ones of the secondary wake suppression dilution openings 63 flows into a dilution wake zone 134 on a downstream side 132 of the primary dilution openings 61 in order to suppress a wake flow that may occur from primary dilution air 82(C) P flowing through the primary dilution opening 61.

Each of the circular dilution openings 100 has a center 104, and a diameter 108, which may be the same diameter 108 for each of the plurality of circular-shaped dilution openings 100, or the diameter 108 may vary for each respective circular-shaped dilution opening 100. When the diameter 108 is the same for each of the plurality of circular-shaped dilution openings 100, the circular-shaped dilution openings 100 may be circumferentially spaced apart by a circumferential spacing distance 106. The circumferential spacing distance 106 may be, for example, greater than or equal to twice the diameter 108 of the circular-shaped dilution openings 100. The plurality of primary dilution openings 61 may also be arranged in a circumferential row such that each of the plurality of primary dilution openings 61 are arranged a longitudinal (or axial) distance 110 downstream of the dome assembly 56 (see also, FIG. 2) centered along a reference plane 126.

Each of the plurality of secondary wake suppression dilution openings 63 is shown in FIG. 3 to be the wedge-shaped dilution openings 102, and, more particularly, is shown to be generally triangular shaped openings that have a base width 112 and a height 114. The base width 112 may be, for example, less than or equal to twice the diameter 108 of the circular-shaped dilution opening 100. In addition, a ratio of the height 114 to the base width 112 may be greater than or equal to one tenth (0.10) such that the base width 112 may be as much as ten times greater than the height 114.

The wedge-shaped dilution openings 102 are circumferentially spaced apart in the circumferential direction (C) with respect to the combustor centerline axis 12′. The wedge-shaped dilution openings 102 may be circumferentially spaced apart a circumferential spacing distance 116, which may be a spacing between a centroid 120 of respective ones of the wedge-shaped dilution openings 102. Respective ones of the plurality of wedge-shaped dilution openings 102 are also circumferentially offset by a circumferential offset amount 122 from respective ones of the plurality of circular-shaped dilution openings 100. The circumferential offset amount 122 may be taken as a circumferential distance between the center 104 of the circular-shaped dilution opening 100 and the centroid 120 of the wedge-shaped dilution opening 102. The plurality of the wedge-shaped dilution openings 102 are also longitudinally offset from respective ones of the circular-shaped dilution openings 100. For example, the center 104 of respective ones of the circular-shaped dilution openings 100 and the centroid 120 of respective ones of the wedge-shaped dilution openings 102 are longitudinally offset by a longitudinal offset amount 124. As shown in FIG. 3, the centroid 120 of each wedge-shaped dilution opening 102 may be longitudinally aligned along a reference plane 118 that passes through the centroid 120 of respective ones of the plurality of wedge-shaped dilution openings 102, where the reference plane 118 is longitudinally offset from the reference plane 126 by the longitudinal offset amount 124. In addition, an apex 119 of each of the wedge-shaped dilution openings 102 may be arranged to either be downstream of the reference plane 126 as shown in FIG. 3. Alternatively, the apex 119 may be arranged at the reference plane 126, or upstream of the reference plane 126.

Each of the primary dilution openings 61 defines a primary dilution opening effective flow area (A_{EffPri}), which is the flattened plan view area of each respective primary dilution opening 61. For each of the circular-shaped dilution openings 100, the effective flow area constitutes the area of the respective circle of each circular-shaped dilution opening 100. A total primary dilution effective flow area (A_{TotalEffPri}) is the sum of the effective flow areas of all of the primary dilution openings 61. Thus, for example, when the total number of primary dilution openings 61 provided through the outer liner 54 is n primary dilution openings 61, the total primary dilution effective flow area is

$${A}_{TotalEffPri} = {\sum }_{1}^{n} {A}_{EffPri} .$$

Similarly, each of the secondary wake suppression dilution openings 63 defines a secondary dilution opening effective flow area (A_{EffSec}), which is the flattened plan view area of each respective secondary wake suppression dilution opening 63. For each of the wedge-shaped dilution openings 102, the effective area constitutes the area of the respective triangle (wedge) of each wedge-shaped dilution opening 102. A total secondary dilution effective flow area (A_{TotalEffSec}) is the sum of the effective flow areas of all of the secondary wake suppression dilution openings 63. Thus, for example, when the total number of secondary wake suppression dilution openings 63 through the outer liner 54 is m secondary wake suppression dilution openings 63, the total secondary dilution effective flow area is

$${A}_{TotalEffSec} = {\sum }_{1}^{m} {A}_{EffSec} .$$

With the foregoing, together, the total primary dilution effective flow area (A_{TotalEffPri}) of the plurality of primary dilution openings 61 and the total secondary dilution effective flow area (A TotalEffSec) of the plurality of secondary wake suppression dilution openings 63 define a total dilution effective flow area (A_{TotalEff}) for the dilution air 82(C) (FIG. 2). A ratio of the total secondary dilution effective flow area (A_{TotalEffSec}) to the total dilution effective flow area (A_{TotalEff}) may have a range from five percent to forty percent, such that:

$$0.05 \leq \frac{{A}_{TotalEffSec}}{{A}_{TotalEff}} \leq 0.4 .$$

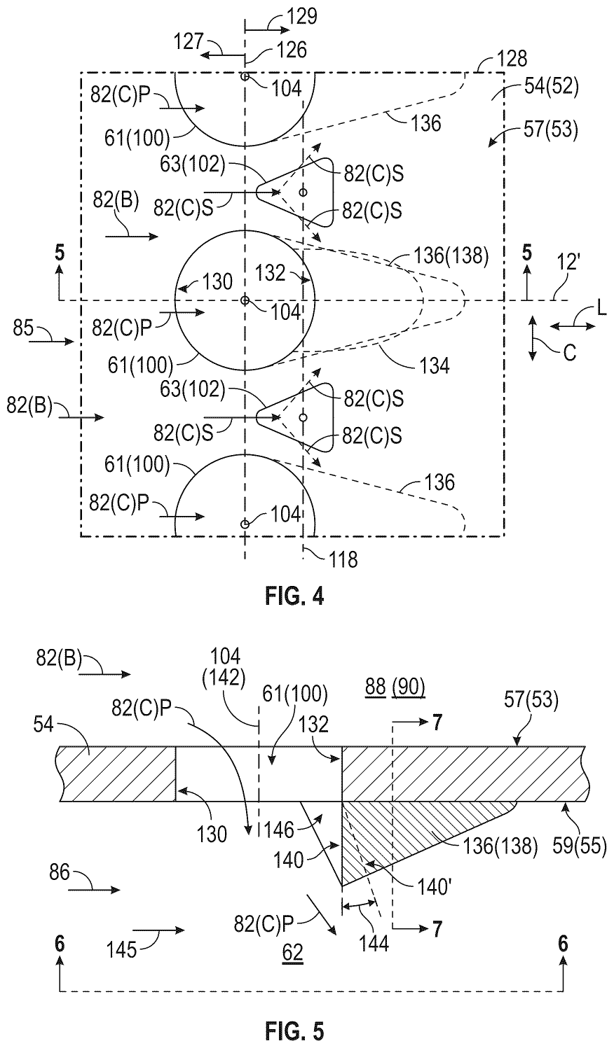

FIG. 4 is an enlarged flattened plan view of a portion of the outer liner 54 of FIG. 3, taken at detail view 128, depicting a dilution airflow pattern according to an aspect of the present disclosure. FIG. 5 is a cross-sectional view of the outer liner 54 of FIG. 4, taken at plane 5-5 of FIG. 4, according to an aspect of the present disclosure. Referring collectively to FIG. 4 and FIG. 5, as shown in FIG. 4 (with dashed lines) and in FIG. 5, the primary dilution openings 61, and, more particularly, the circular-shaped dilution openings 100, include a wake flow suppressor 136 arranged on a downstream side 132 of the circular-shaped dilution opening 100 (i.e., with respect to the flow direction 85, a semi-circular half of the circular-shaped dilution opening 100 on a downstream side 129 of the reference plane 126). The wake flow suppressor 136 extends into the combustion chamber 62 from the hot surface side 59 of the outer liner 54. As will be explained below, in the absence of the wake flow suppressor 136, a dilution wake flow within the dilution airflow 82(C) P flowing through the circular-shaped dilution opening 100 may occur within a dilution wake zone 134 along the downstream side 132 of the circular-shaped dilution opening 100. The wake flow suppressor 136 is arranged to prevent the dilution wake flow in the dilution wake zone 134. An upstream surface 140 of the wake flow suppressor 136 may generally be parallel with a centerline axis 142 through the center 104 of the circular-shaped dilution opening 100. Alternatively, as shown with dashed lines, an angled upstream surface 140′ may be arranged at an angle 144 with respect to the centerline axis 142 to direct the flow of a primary dilution air 82(C) P in a downstream direction 145 within the combustion chamber 62.

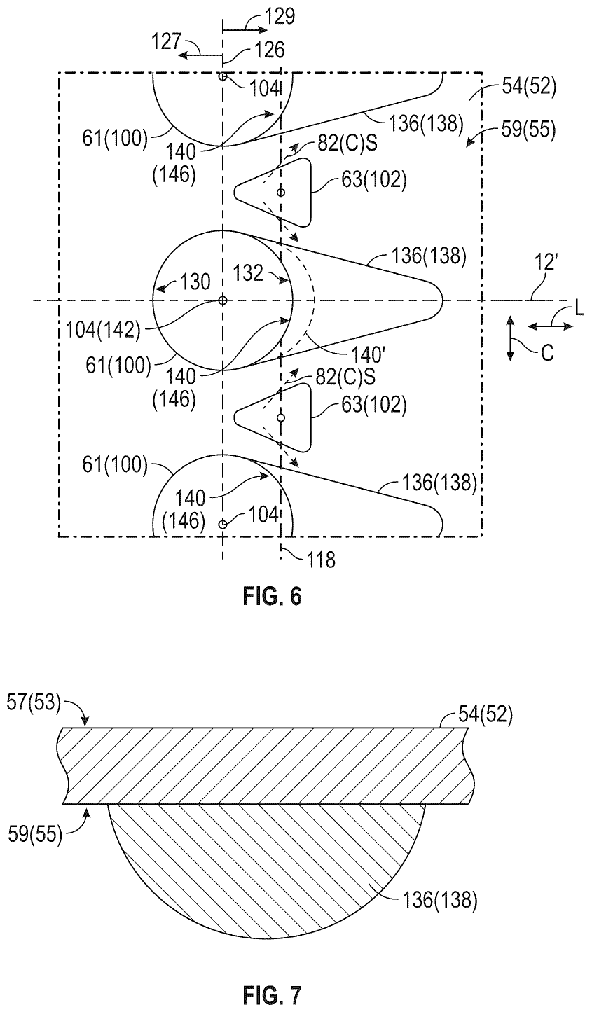

FIG. 6 depicts a flattened plan view of the hot surface side 59 of the portion of the outer liner 54, taken at view 6-6 of FIG. 5, depicting an arrangement of the primary dilution openings 61 and the secondary wake suppression dilution openings 63 through the outer liner 54, according to an aspect of the present disclosure. The FIG. 6 flattened plan view is an opposing flattened plan view to the flattened plan view of FIG. 4 in that FIG. 6 depicts the hot surface side 59, while FIG. 4 depicts the cold surface side 57 of the same portion of the outer liner 54. FIG. 7 is a cross-sectional view taken at plane 7-7 of FIG. 5, through the outer liner 54 and the wake flow suppressor 136, according to an aspect of the present disclosure. As shown in FIG. 5 and FIG. 6, the upstream surface 140 of the wake flow suppressor 136 is a concave surface 146 extending from the downstream side 132 of the circular-shaped dilution opening 100 into the combustion chamber 62. As shown in the flattened plan view of FIG. 6, the wake flow suppressor 136 is a generally semi-oval shaped element, and, in the cross section of FIG. 7, the wake flow suppressor 136 is generally a dome shaped element. Thus, the wake flow suppressor 136 may be referred to as a semi-oval-dome-shaped wake flow suppressor 138.

As shown in FIG. 4 and FIG. 5, as well as FIG. 2, the compressed air 82(B) flowing through the outer flow passage 88 (FIG. 2) passes through the primary dilution openings 61 as primary dilution air 82(C) P and through the secondary wake suppression dilution openings 63 as secondary dilution air 82(C) S into the combustion chamber 62. In FIG. 4 and FIG. 5, the compressed air 82(B) flows across an upstream side 130 of the circular-shaped dilution opening 100 (i.e., a semi-circular half of the circular-shaped dilution opening 100 on an upstream side 127 of the reference plane 126) and through the circular-shaped dilution opening 100 into the combustion chamber 62 as the primary dilution air 82(C) P. At the downstream side 132 of the circular-shaped dilution opening 100, the primary dilution air 82(C) P is deflected by the concave surface 146 of the wake flow suppressor 136 away from the hot surface side 59 of the outer liner 54. The concave surface 146, and the semi-oval-dome shape of the wake flow suppressor 136 reduce (or suppress) a wake flow that may otherwise occur at the downstream side 132 of the circular-shaped dilution opening 100. As also shown in FIG. 4, the secondary dilution air 82(C) S flowing through the wedge-shaped dilution openings 102 flows at least partially laterally (i.e., flows with a circumferential component in the circumferential direction C) toward the wake flow suppressor 136 so as to further reduce the potential for a wake to form around the wake flow suppressor 136.

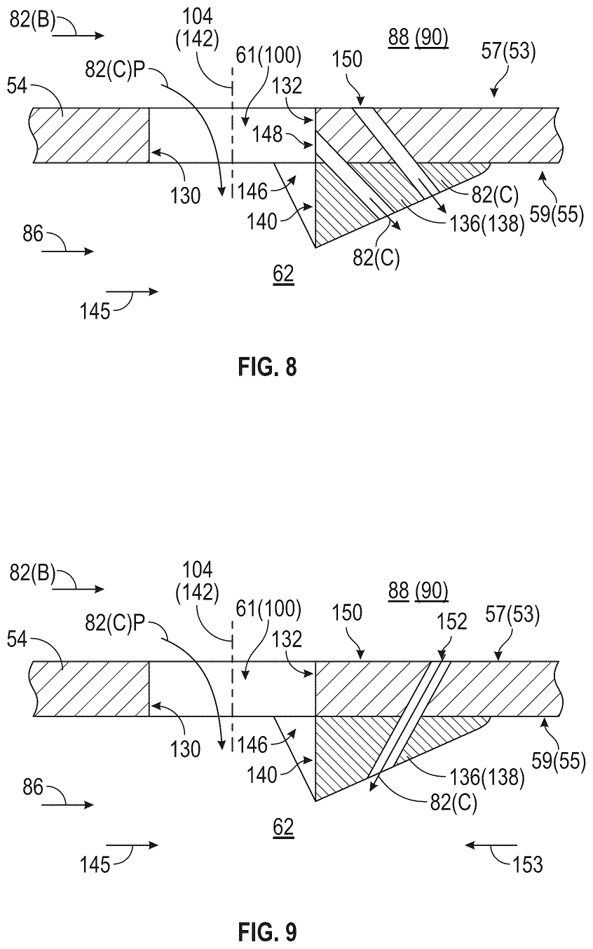

FIG. 8 is a cross-sectional view of an alternate arrangement of the wake flow suppressor 136 to that of FIG. 5, according to an aspect of the present disclosure. In FIG. 8, elements that are the same as those in FIG. 5 include the same reference numerals and the description of those elements provided above for FIG. 5 is also appliable to FIG. 8. In FIG. 8, one or more wake suppression airflow passages are implemented with the wake flow suppressor 136. More specifically, a wake suppression airflow passage 148 may extend through the downstream side 132 of the circular-shaped dilution opening 100 and through the wake flow suppressor 136. In addition, or alternatively, a wake suppression airflow passage 150 may extend through the outer liner 54 and through the wake flow suppressor 136. Both the wake suppression airflow passage 148 and the wake suppression airflow passage 150 provide a flow of the dilution air 82(C) therethrough into the combustion chamber 62 to further suppress the formation of a wake downstream of the primary dilution opening 61.

FIG. 9 is a cross-sectional view of an alternate arrangement of the wake flow suppressor 136 to that of FIG. 8, according to an aspect of the present disclosure. In FIG. 9, elements that are the same as those in FIG. 8 include the same reference numerals and the description of those elements provided above for FIG. 8 is also appliable to FIG. 9. In FIG. 9, at least one wake suppression airflow passage 152 extends through the outer liner 54 and through the wake flow suppressor 136 in an upstream direction 153. The at least one wake suppression airflow passage 152 provides a flow of the dilution air 82(C) therethrough into the combustion chamber 62 in the upstream direction 153 around the wake flow suppressor 136 to further suppress the formation of the wake downstream of the primary dilution opening 61.

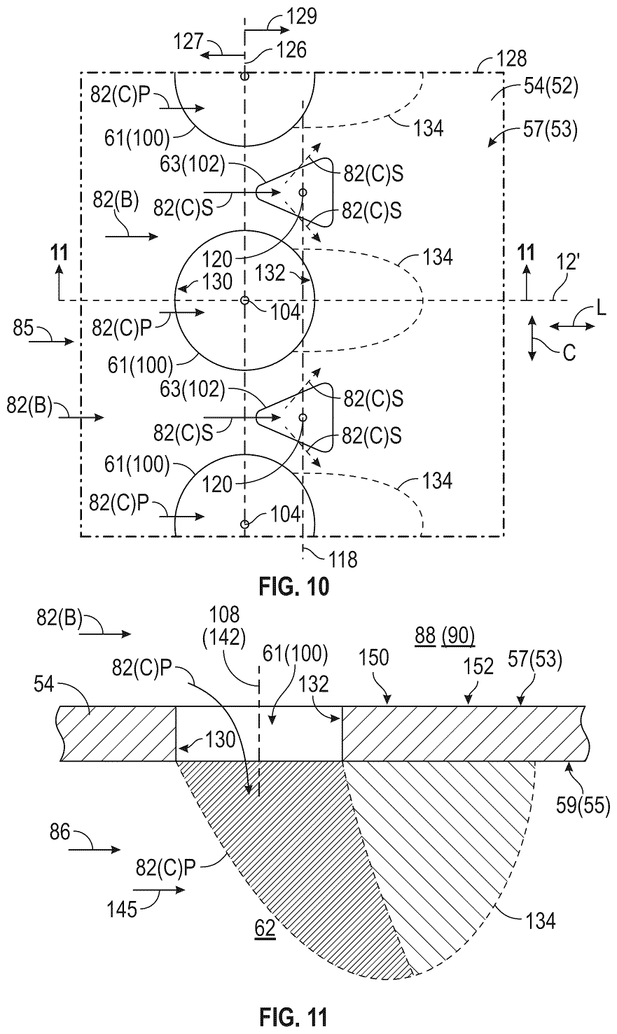

FIG. 10 is a flattened plan view of a portion of an alternate arrangement to that of FIG. 4 of primary dilution openings 61 and secondary wake suppression dilution openings 63, according to an aspect of the present disclosure. FIG. 11 is a cross-sectional view of the alternate arrangement of FIG. 10, taken at plane 11-11 of FIG. 10, according to an aspect of the present disclosure. In FIG. 10 and FIG. 11, elements that are the same as those of FIG. 4 are labeled with the same reference numerals, and the description of those elements provided above for the FIG. 4 aspect is also applicable to the FIG. 10 aspect and the FIG. 11 aspect. In the FIG. 10 aspect and the FIG. 11 aspect, in contrast to the FIG. 4 aspect, the wake flow suppressor 136 is not included. Due to the absence of the wake flow suppressor 136, the dilution wake zone 134 may form at the downstream side 132 of the circular-shaped dilution opening 100. However, as was described above for the FIG. 4 aspect, the secondary dilution air 82(C) S flowing through the wedge-shaped dilution openings 102 flows at least partially laterally (i.e., flows with a circumferential component in the circumferential direction C as shown in dashed lines) toward the dilution wake zone 134. The secondary dilution air 82(C) S flowing laterally mixes with the combustion gases 86 within the dilution wake zone 134 so as to provide a dilution airflow to the dilution wake zone 134, thereby reducing or suppressing the dilution wake zone 134.

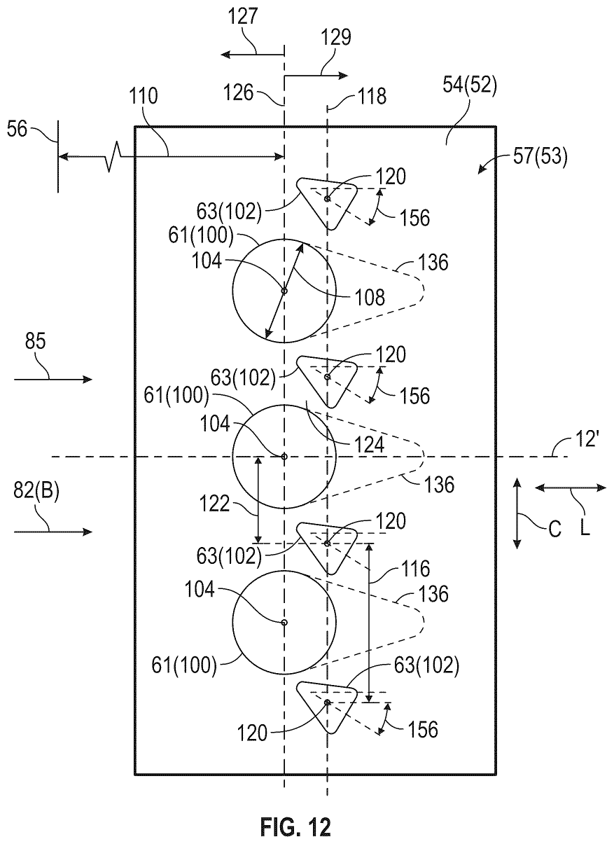

FIG. 12 is a flattened plan view of a cold surface side of an alternate arrangement of the portion of an outer liner of FIG. 3, according to an aspect of the present disclosure. In FIG. 12, elements that are the same as those of the FIG. 3 aspect include the same reference numerals and the description provided above for FIG. 3 of those same elements is equally applicable to the FIG. 12 aspect. One difference, however, between the alternate arrangement of FIG. 12 with the arrangement of FIG. 3 is that the secondary wake suppression dilution openings 63, and, more particularly, the wedge-shaped dilution openings 102, are arranged at an angle 156 with respect to the combustor centerline axis 12′. By angling the secondary wake suppression dilution openings 63 at the angle 156, the flow of the secondary dilution air 82(C) S can be provided with a circumferential flow component into the combustion chamber 62. The circumferential component may be commensurate with the swirl direction 67 (FIG. 2) of the combustion gases 86 within the combustion chamber 62. While FIG. 12 depicts the secondary wake suppression dilution openings 63 being angled and being implemented in conjunction with the wake flow suppressor 136, the secondary wake suppression dilution openings 63 of the FIG. 10 aspect, in which the wake flow suppressor 136 is not implemented, may also be angled at the angle 156 as shown in FIG. 12.

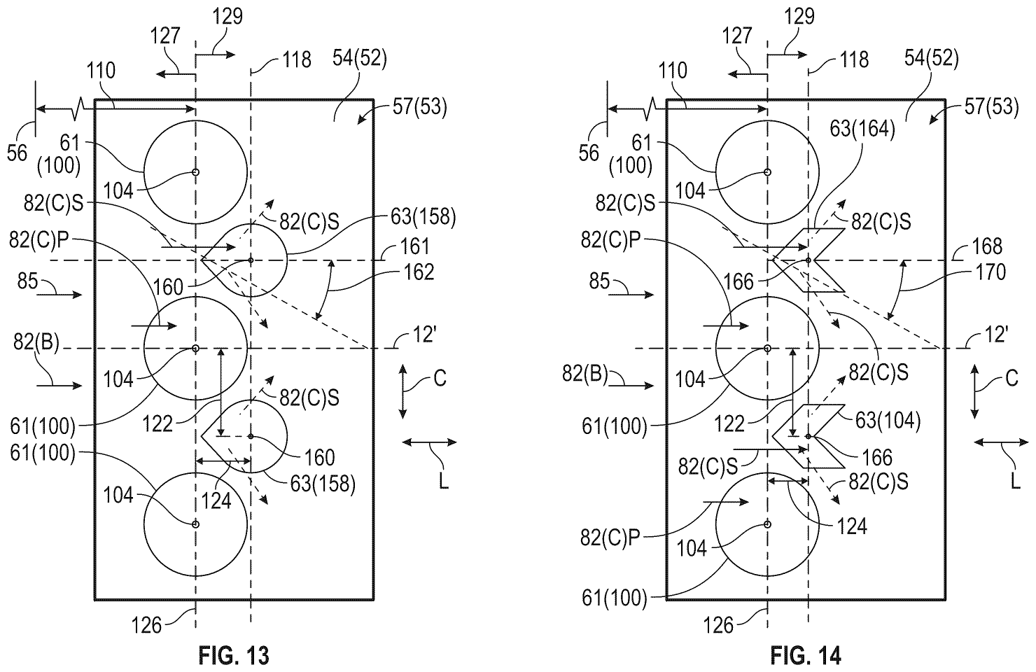

Each of the foregoing aspects includes the secondary wake suppression dilution openings 63 as the wedge-shaped dilution openings 102 and as generally being a triangular-shaped opening. However, the secondary wake suppression dilution openings 63 may have a different shape than the wedge shape. FIG. 13 is a flattened plan view of a cold surface side 57 of the outer liner 54 depicting an alternate arrangement to that of FIG. 3, according to an aspect of the present disclosure. In FIG. 13, elements that are the same as those of FIG. 3 include the same reference numerals, and the description provided above for FIG. 3 of those elements is also applicable to the FIG. 13 aspect. In FIG. 13, the plurality of secondary wake suppression dilution openings 63 are shown to be teardrop-shaped dilution openings 158. Each of the teardrop-shaped dilution openings 158 includes a centroid 160, which may be arranged along the reference plane 118. A centerline axis 161 of the teardrop-shaped dilution opening 158 extends through the centroid 160 and is parallel to the combustor centerline axis 12′. The teardrop-shaped dilution opening 158, as shown in FIG. 13, is arranged generally symmetrical with respect to the centerline axis 161. However, the teardrop-shaped dilution opening 158 may be angled at an angle 162 such that the centerline axis 161 extends at the angle 162. In FIG. 13, the wake flow suppressor 136 (FIG. 3) is not shown as being included, but the FIG. 13 aspect may include the wake flow suppressor 136 in the same manner as described above for FIG. 3.

FIG. 14 is a flattened plan view of a cold surface side 57 of the outer liner 54 depicting another alternate arrangement to that of FIG. 3, according to an aspect of the present disclosure. In FIG. 14, elements that are the same as those of FIG. 3 include the same reference numerals, and the description provided above for FIG. 3 of those elements is also applicable to the FIG. 14 aspect. In FIG. 14, the plurality of secondary wake suppression dilution openings 63 are shown to be chevron-shaped dilution openings 164. Each of the chevron-shaped dilution openings 164 includes a centroid 166, which may be arranged along the reference plane 118. A centerline axis 168 of the chevron-shaped dilution opening 164 extends through the centroid 166 and is parallel to the combustor centerline axis 12′. The chevron-shaped dilution opening 164, as shown in FIG. 14, is arranged generally symmetrical with respect to the centerline axis 168. However, the chevron-shaped dilution opening 164 may be angled at an angle 170 such that the centerline axis 168 extends at the angle 170. In FIG. 14, the wake flow suppressor 136 (FIG. 3) is not shown as being included, but the FIG. 14 aspect may include the wake flow suppressor 136 in the same manner as described above for FIG. 3.

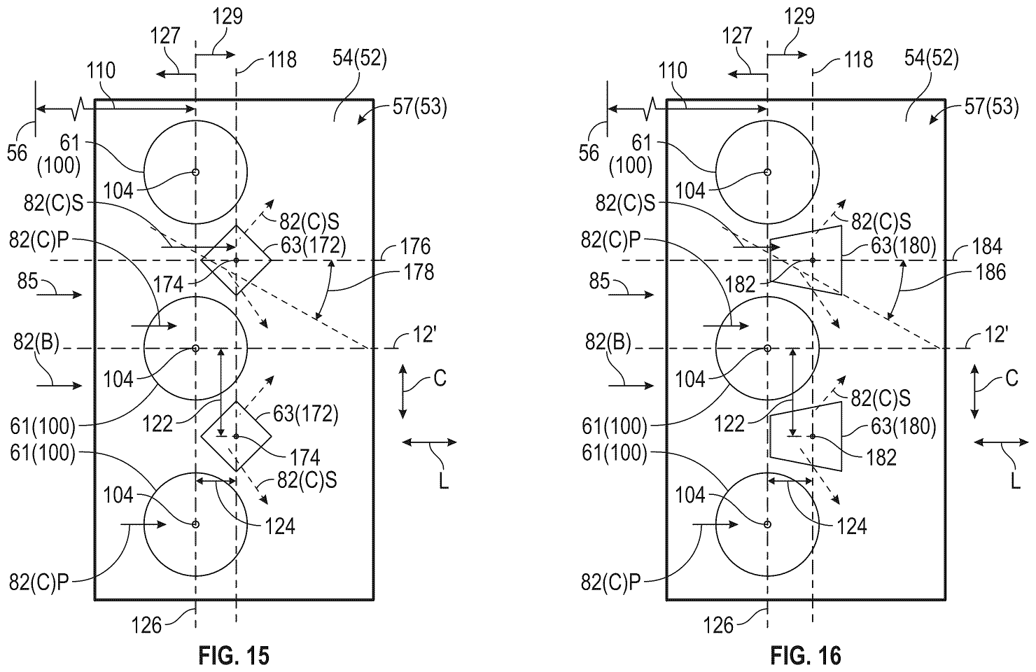

FIG. 15 is a flattened plan view of a cold surface side 57 of the outer liner 54 depicting another alternate arrangement to that of FIG. 3, according to an aspect of the present disclosure. In FIG. 15, elements that are the same as those of FIG. 3 include the same reference numerals, and the description provided above for FIG. 3 of those elements is also applicable to the FIG. 15 aspect. In FIG. 15, the plurality of secondary wake suppression dilution openings 63 are shown to be diamond-shaped dilution openings 172. Each of the diamond-shaped dilution openings 172 includes a centroid 174, which may be arranged along the reference plane 118. A centerline axis 176 of the diamond-shaped dilution opening 172 extends through the centroid 174 and is parallel to the combustor centerline axis 12′. The diamond-shaped dilution opening 172, as shown in FIG. 15, is arranged generally symmetrical with respect to the centerline axis 176. However, the diamond-shaped dilution opening 172 may be angled at an angle 178 such that the centerline axis 176 extends at the angle 178. In FIG. 15, the wake flow suppressor 136 (FIG. 3) is not shown as being included, but the FIG. 15 aspect may include the wake flow suppressor 136 in the same manner as described above for FIG. 3.

FIG. 16 is a flattened plan view of a cold surface side 57 of the outer liner 54 depicting another alternate arrangement to that of FIG. 3, according to an aspect of the present disclosure. In FIG. 16, elements that are the same as those of FIG. 3 include the same reference numerals, and the description provided above for FIG. 3 of those elements is also applicable to the FIG. 16 aspect. In FIG. 16, the plurality of secondary wake suppression dilution openings 63 are shown to be isosceles-trapezoid-shaped dilution openings 180. Each of the isosceles-trapezoid-shaped dilution openings 180 includes a centroid 182, which may be arranged along the reference plane 118. A centerline axis 184 of the isosceles-trapezoid-shaped dilution opening 180 extends through the centroid 182 and is parallel to the combustor centerline axis 12′. The isosceles-trapezoid-shaped dilution opening 180, as shown in FIG. 16, is arranged generally symmetrical with respect to the centerline axis 184. However, the isosceles-trapezoid-shaped dilution opening 180 may be angled at an angle 186 such that the centerline axis 184 extends at the angle 186. In FIG. 16, the wake flow suppressor 136 (FIG. 3) is not shown as being included, but the FIG. 16 aspect may include the wake flow suppressor 136 in the same manner as described above for FIG. 3.

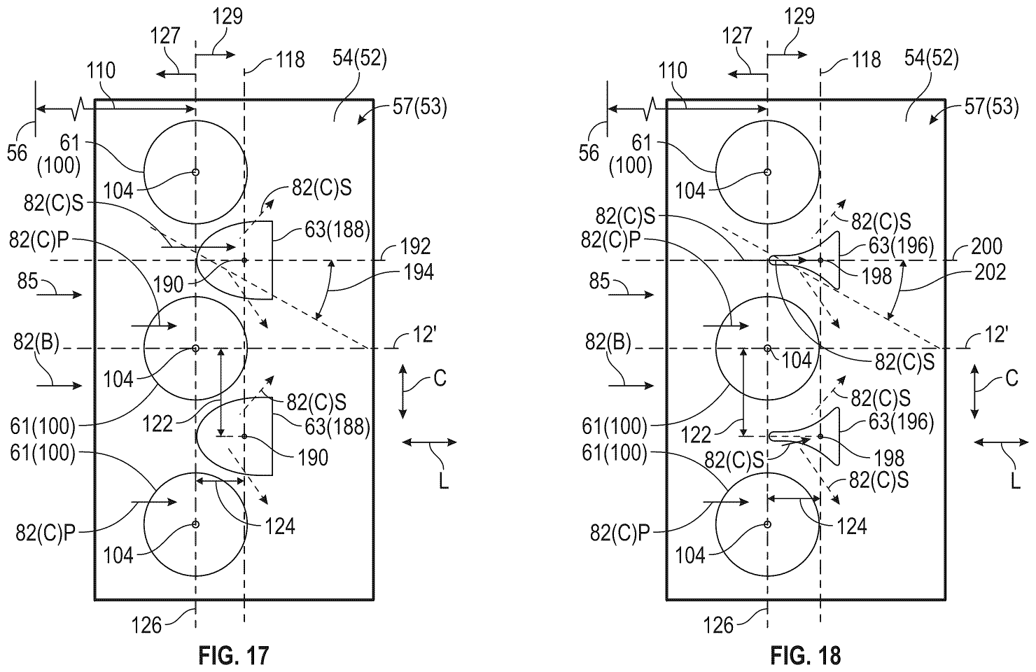

FIG. 17 is a flattened plan view of a cold surface side 57 of the outer liner 54 depicting another alternate arrangement to that of FIG. 3, according to an aspect of the present disclosure. In FIG. 17, elements that are the same as those of FIG. 3 include the same reference numerals, and the description provided above for FIG. 3 of those elements is also applicable to the FIG. 17 aspect. In FIG. 17, the plurality of secondary wake suppression dilution openings 63 are shown to be shield-shaped dilution openings 188. Each of the shield-shaped dilution openings 188 includes a centroid 190, which may be arranged along the reference plane 118. A centerline axis 192 of the shield-shaped dilution opening 188 extends through the centroid 190 and is parallel to the combustor centerline axis 12′. The shield-shaped dilution opening 188, as shown in FIG. 17, is arranged generally symmetrical with respect to the centerline axis 192. However, the shield-shaped dilution opening 188 may be angled at an angle 194 such that the centerline axis 192 extends at the angle 194. In FIG. 17, the wake flow suppressor 136 (FIG. 3) is not shown as being included, but the FIG. 17 aspect may include the wake flow suppressor 136 in the same manner as described above for FIG. 3.

FIG. 18 is a flattened plan view of a cold surface side 57 of the outer liner 54 depicting another alternate arrangement to that of FIG. 3, according to an aspect of the present disclosure. In FIG. 18, elements that are the same as those of FIG. 3 include the same reference numerals, and the description provided above for FIG. 3 of those elements is also applicable to the FIG. 18 aspect. In FIG. 18, the plurality of secondary wake suppression dilution openings 63 are shown to be horn-shaped dilution openings 196. Each of the horn-shaped dilution openings 196 includes a centroid 198, which may be arranged along the reference plane 118. A centerline axis 200 of the horn-shaped dilution opening 196 extends through the centroid 199 and is parallel to the combustor centerline axis 12′. The horn-shaped dilution opening 196, as shown in FIG. 18, is arranged generally symmetrical with respect to the centerline axis 200. However, the horn-shaped dilution opening 196 may be angled at an angle 202 such that the centerline axis 200 extends at the angle 202. In FIG. 18, the wake flow suppressor 136 (FIG. 3) is not shown as being included, but the FIG. 18 aspect may include the wake flow suppressor 136 in the same manner as described above for FIG. 3.

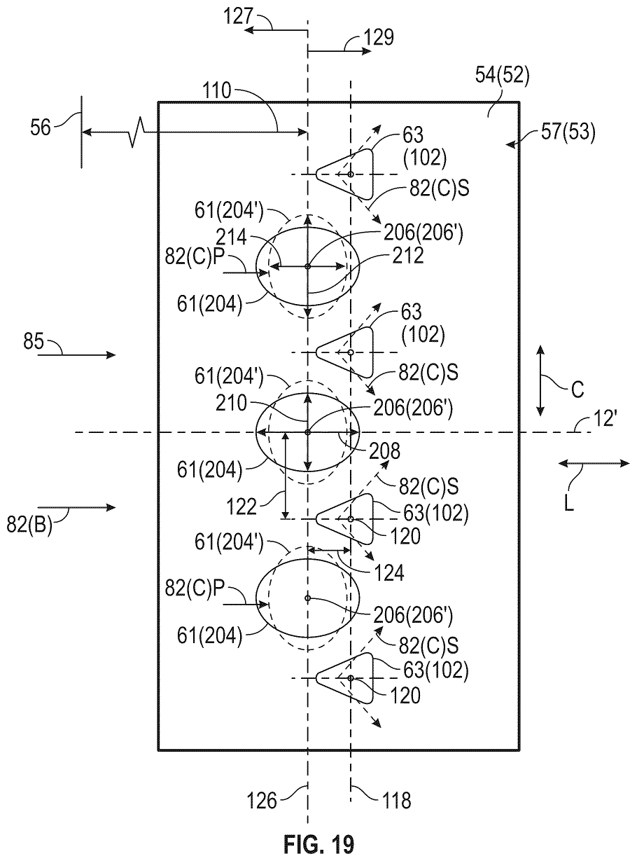

In each of the foregoing aspects, the primary dilution openings 61 are described as being the circular-shaped dilution opening 100. However, the primary dilution openings 61 are not limited to being the circular-shaped dilution openings 100 and other shapes may be implemented instead. FIG. 19 is a flattened plan view of a cold surface side 57 of the outer liner 54 depicting another alternate arrangement to that of FIG. 3, according to an aspect of the present disclosure. In FIG. 19, elements that are the same as those of FIG. 3 include the same reference numerals, and the description provided above for FIG. 3 of those elements is also applicable to the FIG. 19 aspect. In FIG. 19, the plurality of primary dilution openings 61 are shown to be oval-shaped dilution openings 204. The oval-shaped dilution openings 204 include a centroid 206 that may be arranged along the reference plane 126, and may be arranged so that a major axis 208 extends along the longitudinal direction (L) with respect to the combustor centerline axis 12′ and so that a minor axis 210 extends in the circumferential direction (C). Alternatively, an oval-shaped dilution opening 204′ may be implemented, where the oval-shaped dilution opening 204′ has a centroid 206′ arranged along the reference plane 126, but a major axis 212 extends in the circumferential direction (C) and a minor axis 214 extends in the longitudinal direction (L).

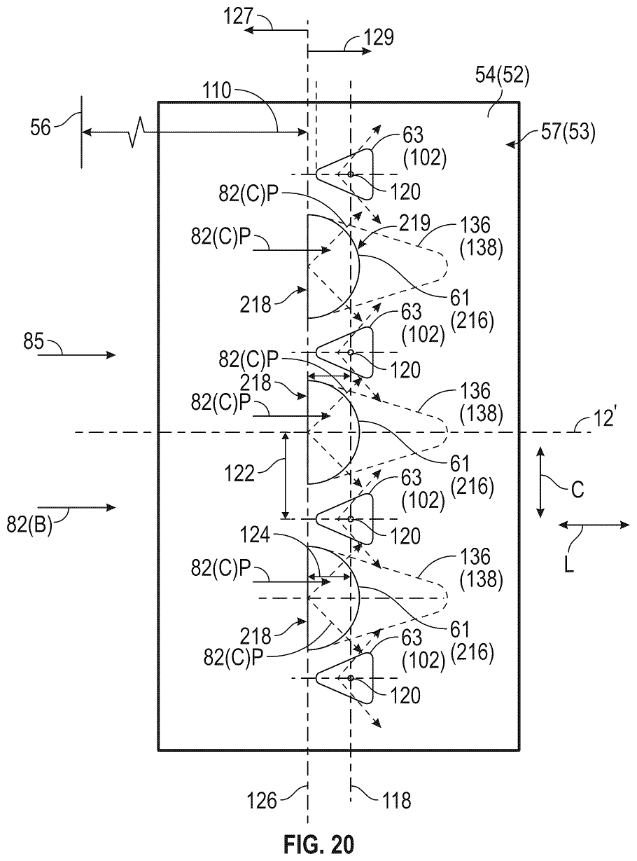

FIG. 20 is a flattened plan view of a cold surface side 57 of the outer liner 54 depicting another alternate arrangement to that of FIG. 3, according to an aspect of the present disclosure. In FIG. 20, elements that are the same as those of FIG. 3 include the same reference numerals, and the description provided above for FIG. 3 of those elements is also applicable to the FIG. 20 aspect. In FIG. 20, the plurality of primary dilution openings 61 are shown to be semi-circular-shaped dilution openings 216. In FIG. 20, the semi-circular-shaped dilution openings 216 are shown with an upstream edge 218 (a straight portion) being arranged along the reference plane 126 and an arched portion 219 being arranged downstream of the reference plane 126. However, the semi-circular-shaped dilution openings 216 may be arranged with the upstream edge 218 being either on the upstream side 127 of the reference plane 126, or on the downstream side 129 of the reference plane 126. The semi-circular-shaped dilution openings 216 may provide for a more lateral spread of the primary dilution air 82(C) P when compared with the circular-shaped dilution openings 100.

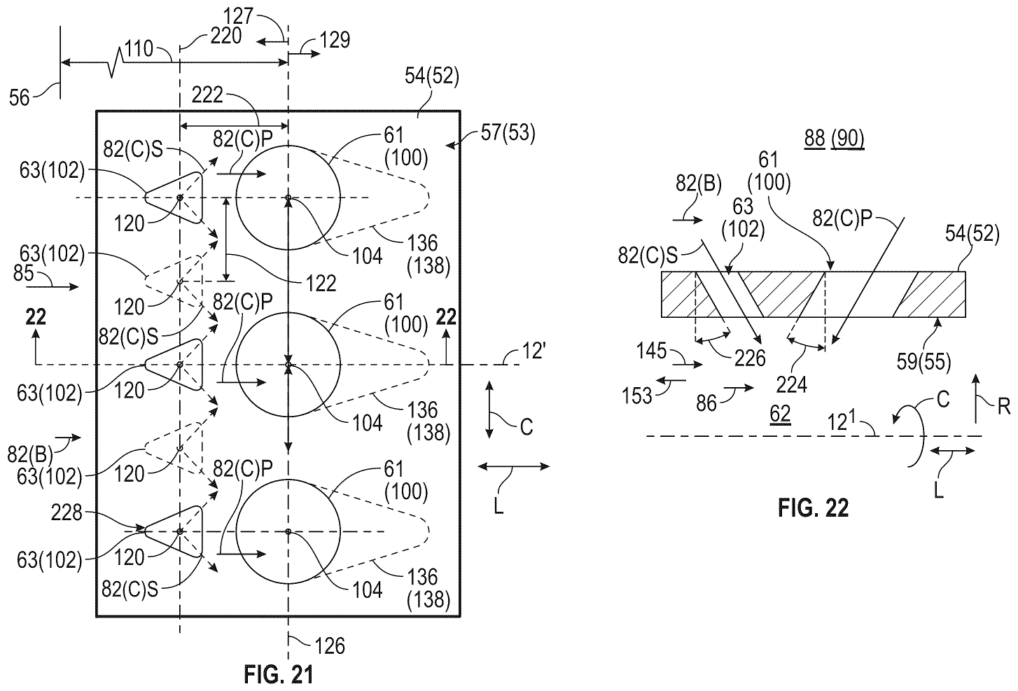

FIG. 21 is a flattened plan view of a cold surface side 57 of the outer liner 54 depicting another alternate arrangement to that of FIG. 3, according to an aspect of the present disclosure. In FIG. 21, elements that are the same as those of FIG. 3 include the same reference numerals, and the description provided above for FIG. 3 of those elements is also applicable to the FIG. 21 aspect. In FIG. 21, the plurality of secondary wake suppression dilution openings 63 are located on the upstream side 127 of the reference plane 126 rather than being located on the downstream side 129 of the reference plane 126 as shown in FIG. 3. In FIG. 21, the centroid 120 of each of the plurality of secondary wake suppression dilution openings 63 is shown as being arranged along a reference plane 220 that is shifted by a longitudinal offset amount 222 on the upstream side 127 of the reference plane 126. In addition, in FIG. 21, the centroid 120 of each of the plurality of secondary wake suppression dilution openings 63 may be arranged circumferentially aligned with the center 104 of respective ones of the plurality of primary dilution openings 61. Alternatively, as shown in dashed lines, the centroid 120 of each of the plurality of secondary wake suppression dilution openings 63 may be offset circumferentially from the center 104 by the circumferential offset amount 122. In yet another arrangement, the outer liner 54 may include both the circumferentially aligned secondary wake suppression dilution openings 63 (as shown with solid lines) and the circumferentially offset secondary wake suppression dilution openings 63 (as shown in dashed lines).

FIG. 22 is a cross-sectional view taken at plane 22-22 of FIG. 21, according to an aspect of the present disclosure. In FIG. 22, the primary dilution opening 61 is shown to be angled in the upstream direction 153 at an upstream angle 224 with respect to the radial direction (R), and the secondary wake suppression dilution opening 63 is shown to be angled in the downstream direction 145 at a downstream angle 226 with respect to the radial direction (R). As a result, the secondary dilution air 82(C) S flows in the downstream direction 145 into the combustion chamber 62, and the primary dilution air 82(C) P flows in the upstream direction 153 into the combustion chamber 62 so that the two dilution airflows (82(C) P and 82(C) S) converge with one another.

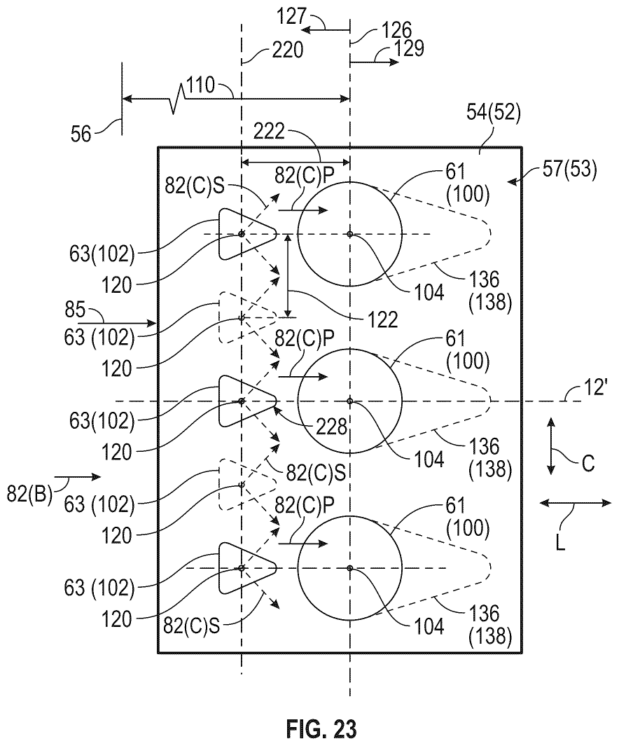

FIG. 23 is a flattened plan view of a cold surface side 57 of the outer liner 54 depicting another alternate arrangement to that of FIG. 21, according to an aspect of the present disclosure. In FIG. 23, elements that are the same as those of FIG. 21 include the same reference numerals, and the description provided above for FIG. 21 of those elements is also applicable to the FIG. 23 aspect. One difference between the FIG. 23 aspect and the FIG. 21 aspect is the orientation of the plurality of secondary wake suppression dilution openings 63 in that, in the FIG. 23 aspect, the plurality of secondary wake suppression dilution openings 63 are arranged with an apex 228 on a downstream side rather than being arranged on an upstream side as shown in FIG. 21.

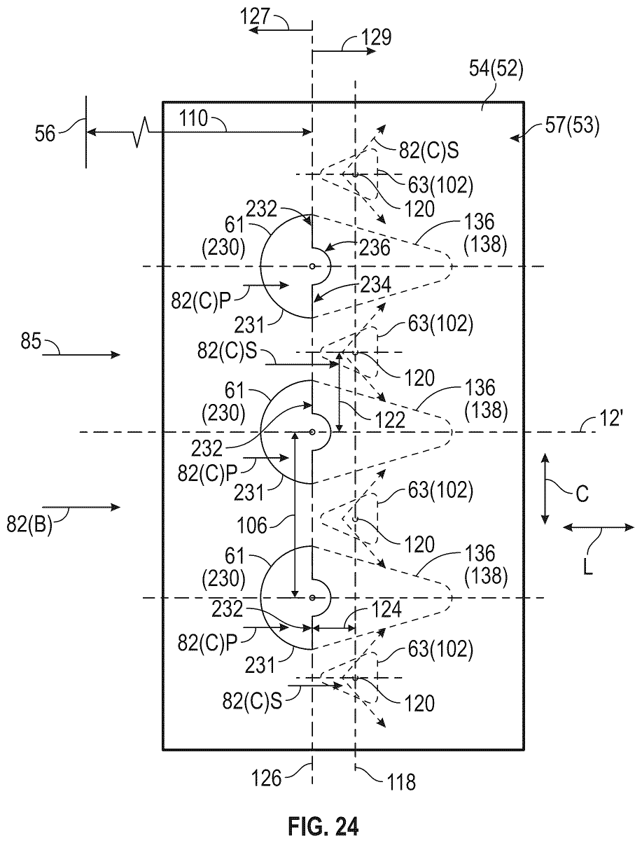

FIG. 24 is a flattened plan view of a cold surface side 57 of the outer liner 54 depicting another alternate arrangement to that of FIG. 3, according to an aspect of the present disclosure. In FIG. 24, elements that are the same as those of FIG. 3 include the same reference numerals, and the description provided above for FIG. 3 of those elements is also applicable to the FIG. 24 aspect. In FIG. 24, the plurality of primary dilution openings 61 are shown to be semi-circular-shaped dilution openings 230. In FIG. 24, the semi-circular-shaped dilution openings 230 are shown with a rounded side 231 being arranged on the upstream side 130 (FIG. 6) of the primary dilution opening 61, and a downstream edge 232 (e.g., a generally straight edge) being arranged along the reference plane 126. However, the semi-circular-shaped dilution openings 230 may be arranged with the downstream edge 232 being either on the upstream side 127 of the reference plane 126, or on the downstream side 129 of the reference plane 126. In FIG. 24, the wake flow suppressor 136 is included with the semi-circular-shaped dilution openings 230, and is arranged along the downstream edge 232. In FIG. 24, the wake flow suppressor 136 includes a concave surface 236 extending from the downstream edge 232 on an upstream side 234 of the wake flow suppressor 136. The concave surface 236 may be similar to the concave surface 146 (FIG. 5). The secondary wake suppression dilution openings 63 may be included with the FIG. 24 aspect, but may also be optional, and, therefore, are shown with dashed lines. The semi-circular-shaped dilution openings 230 may provide for a more lateral spread of the primary dilution air 82(C) P when compared with the circular-shaped dilution openings 100.

Further aspects of the present disclosure are provided by the subject matter of the following clauses.

A combustor for a gas turbine, the combustor including an outer casing and an inner casing, each extending circumferentially about a combustor centerline axis, an outer liner extending circumferentially about the combustor centerline axis, and an inner liner extending circumferentially about the combustor centerline axis, a combustion chamber being defined between the outer liner and the inner liner, an outer flow passage being defined between the outer casing and the outer liner, and an inner flow passage being defined between the inner casing and the inner liner, wherein at least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings.

The combustor according to the preceding clause, wherein a total primary dilution effective flow area of the plurality of primary dilution openings and a total secondary dilution effective flow area of the plurality of secondary wake suppression dilution openings define a total dilution effective flow area for dilution air, and a ratio of the total secondary dilution effective flow area to the total dilution effective flow area is in a range from five percent to forty percent.

The combustor according to any preceding clause, wherein the plurality of primary dilution openings are circumferentially spaced apart from one another, and the plurality of secondary wake suppression dilution openings are circumferentially spaced apart from one another.

The combustor according to any preceding clause, wherein each of the plurality of secondary wake suppression dilution openings is circumferentially offset from respective ones of the plurality of primary dilution openings.

The combustor according to any preceding clause, wherein each of the plurality of secondary wake suppression dilution openings is longitudinally offset, with respect to the combustor centerline axis, from the plurality of primary dilution openings.

The combustor according to any preceding clause, wherein each of the primary dilution openings is a circular-shaped dilution opening, and each of the plurality of secondary wake suppression dilution openings is a teardrop-shaped dilution opening.

The combustor according to any preceding clause, wherein each of the primary dilution openings is a circular-shaped dilution opening, and each of the plurality of secondary wake suppression dilution openings is a chevron-shaped dilution opening.

The combustor according to any preceding clause, wherein each of the primary dilution openings is a circular-shaped dilution opening, and each of the plurality of secondary wake suppression dilution openings is a diamond-shaped dilution opening.

The combustor according to any preceding clause, wherein each of the primary dilution openings is a circular-shaped dilution opening, and each of the plurality of secondary wake suppression dilution openings is an isosceles-trapezoid-shaped dilution opening.

The combustor according to any preceding clause, wherein each of the primary dilution openings is a circular-shaped dilution opening, and each of the plurality of secondary wake suppression dilution openings is a shield-shaped dilution opening.

The combustor according to any preceding clause, wherein each of the primary dilution openings is a circular-shaped dilution opening, and each of the plurality of secondary wake suppression dilution openings is a horn-shaped dilution opening.

The combustor according to any preceding clause, wherein each of the primary dilution openings is a semi-circular-shaped dilution opening, and each of the plurality of secondary wake suppression dilution openings is a wedge-shaped dilution opening, a rounded side of the semi-circular-shaped dilution opening being arranged on an upstream side of the primary dilution opening.

The combustor according to any preceding clause, wherein at least one of the plurality of primary dilution openings includes a wake flow suppressor arranged on a downstream edge of the semi-circular-shaped dilution opening, and extending into the combustion chamber.

The combustor according to any preceding clause, wherein the wake flow suppressor is a semi-oval-dome-shaped wake flow suppressor, and an upstream side of the wake flow suppressor includes a concave surface extending from the downstream edge of semi-circular-shaped dilution opening into the combustion chamber.

The combustor according to any preceding clause, wherein the at least one of the outer liner or the inner liner further includes at least one secondary airflow opening extending therethrough downstream of the primary dilution opening and extending through the wake flow suppressor to provide a secondary airflow into the combustion chamber downstream of the primary dilution opening.

The combustor according to any preceding clause, wherein each of the primary dilution openings is a circular-shaped dilution opening, and each of the plurality of secondary wake suppression dilution openings is a wedge-shaped dilution opening.

The combustor according to any preceding clause, wherein at least one of the secondary wake suppression dilution openings is angled with respect to a longitudinal direction of the combustor centerline axis.

The combustor according to any preceding clause, wherein at least one of the plurality of primary dilution openings includes a wake flow suppressor arranged on a downstream side of the circular-shaped dilution opening, and extending into the combustion chamber.

The combustor according to any preceding clause, wherein the wake flow suppressor is semi-oval-dome shaped and an upstream surface of the wake flow suppressor includes a concave surface extending from the downstream side of circular-shaped dilution opening into the combustion chamber.

The combustor according to any preceding clause, wherein the upstream surface of the wake flow suppressor is angled to direct the flow of the primary dilution air in a downstream direction within the combustion chamber.

The combustor according to any preceding clause, wherein the primary dilution openings are oval-shaped openings.

The combustor according to any preceding clause, wherein the over-shaped dilution openings have a major axis and a minor axis with respect to the combustor centerline axis, and the major axis extends in a longitudinal direction with respect to the combustor centerline axis and the minor axis extends in a circumferential direction with respect to the combustor centerline axis.

The combustor according to any preceding clause, wherein the oval-shaped dilution openings have a major axis and a minor axis with respect to the combustor centerline axis, and the major axis extends in a circumferential direction with respect to the combustor centerline axis and the minor axis extends in a longitudinal direction with respect to the combustor centerline axis.

The combustor according to any preceding clause, wherein the oval-shaped dilution openings include a centroid arranged along a first reference plane and the secondary wake suppression dilution openings have a centroid arranged along a second reference plane downstream of the first reference plane.

The combustor according to any preceding clause, wherein the primary dilution openings are semi-circular shaped dilution openings having an arched portion and a straight portion.

The combustor according to any preceding clause, wherein the straight portion is an upstream edge of the semi-circular shaped dilution opening, and the upstream edge is arranged along a reference plane extending perpendicular to the combustor centerline axis.

The combustor according to any preceding clause, wherein the straight portion is an upstream edge of the semi-circular shaped dilution opening, and the upstream edge is arranged upstream of a reference plane extending perpendicular to the combustor centerline axis.

The combustor according to any preceding clause, wherein the straight portion is an upstream edge of the semi-circular shaped dilution opening, and the upstream edge is arranged downstream of a reference plane extending perpendicular to the combustor centerline axis.

The combustor according to any preceding clause, wherein the primary dilution opening includes a wake flow suppressor arranged downstream of the arched portion.

The combustor according to any preceding clause, wherein a centroid of each of the plurality of primary dilution openings is arranged along a reference plane extending perpendicular to the combustor centerline axis, and a centroid of each of the plurality of secondary wake suppression dilution openings is arranged upstream of the reference plane.

The combustor according to any preceding clause, wherein a respective one of the plurality of secondary wake suppression dilution openings is arranged upstream of a respective one of the plurality of primary dilution openings.

The combustor according to any preceding clause, wherein the centroid of the respective one of the plurality of secondary wake suppression dilution openings and the centroid of the respective one of plurality of primary dilution openings are longitudinally aligned with each other.

The combustor according to any preceding clause, wherein the centroid of the respective one of the plurality of secondary wake suppression dilution openings and the centroid of the respective one of plurality of primary dilution openings are longitudinally offset from each other.

The combustor according to any preceding clause, wherein each of the plurality of primary dilution openings includes a wake flow suppressor arranged along a downstream side of the primary dilution opening.

The combustor according to any preceding clause, wherein each of the plurality of primary dilution openings is angled through the combustor liner in an upstream direction at an upstream angle, and each of the secondary wake flow suppression dilution openings is angled in a downstream direction at a downstream angle.

The combustor according to any preceding clause, wherein each of the secondary wake suppression dilution openings is a wedge-shaped dilution opening, and an apex of the wedge-shaped dilution opening is arranged on an upstream side of the wedge-shaped dilution opening.

The combustor according to any preceding clause, wherein each of the secondary wake suppression dilution openings is a wedge-shaped dilution opening, and an apex of the wedge-shaped dilution opening is arranged on an downstream side of the wedge-shaped dilution opening.

A combustor for a gas turbine, the combustor including an outer casing and an inner casing, each extending circumferentially about a combustor centerline axis, an outer liner extending circumferentially about the combustor centerline axis, and an inner liner extending circumferentially about the combustor centerline axis, a combustion chamber being defined between the outer liner and the inner liner, an outer flow passage being defined between the outer casing and the outer liner, and an inner flow passage being defined between the inner casing and the inner liner, wherein at least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings, and wherein each of the primary dilution openings is a circular-shaped dilution opening, and each of the plurality of secondary wake suppression dilution openings is a wedge-shaped dilution opening.

The combustor according to the preceding clause, wherein at least one of the secondary wake suppression dilution openings is angled with respect to a longitudinal direction of the combustor centerline axis.

The combustor according to any preceding clause, wherein at least one of the plurality of primary dilution openings includes a wake flow suppressor arranged on a downstream side of the circular-shaped dilution opening, and extending into the combustion chamber.

The combustor according to any preceding clause, wherein the wake flow suppressor is semi-oval-dome shaped and an upstream surface of the wake flow suppressor includes a concave surface extending from the downstream side of circular-shaped dilution opening into the combustion chamber.

The combustor according to any preceding clause, wherein the upstream surface of the wake flow suppressor is angled to direct the flow of the primary dilution air in a downstream direction within the combustion chamber.

A combustor for a gas turbine, the combustor including an outer casing and an inner casing, each extending circumferentially about a combustor centerline axis, an outer liner extending circumferentially about the combustor centerline axis, and an inner liner extending circumferentially about the combustor centerline axis, a combustion chamber being defined between the outer liner and the inner liner, an outer flow passage being defined between the outer casing and the outer liner, and an inner flow passage being defined between the inner casing and the inner liner, wherein at least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings, and wherein each of the primary dilution openings is a circular-shaped dilution opening, and each of the plurality of secondary wake suppression dilution openings is a horn-shaped dilution opening.

The combustor according to the preceding clause, wherein each of the primary dilution openings is a semi-circular-shaped dilution opening, and each of the plurality of secondary wake suppression dilution openings is a wedge-shaped dilution opening, a rounded side of the semi-circular-shaped dilution opening being arranged on an upstream side of the primary dilution opening.

The combustor according to any preceding clause, wherein at least one of the plurality of primary dilution openings includes a wake flow suppressor arranged on a downstream edge of the semi-circular-shaped dilution opening, and extending into the combustion chamber.

The combustor according to any preceding clause, wherein the wake flow suppressor is a semi-oval-dome-shaped wake flow suppressor, and an upstream side of the wake flow suppressor includes a concave surface extending from the downstream edge of semi-circular-shaped dilution opening into the combustion chamber.

The combustor according to any preceding clause, wherein the at least one of the outer liner or the inner liner further includes at least one secondary airflow opening extending therethrough downstream of the primary dilution opening and extending through the wake flow suppressor to provide a secondary airflow into the combustion chamber downstream of the primary dilution opening.

A gas turbine engine including, in a serial flow relationship, a compressor section, a combustor, and a turbine section, the compressor section providing a flow of compressed air to the combustor, the combustor including an outer casing and an inner casing, each extending circumferentially about a combustor centerline axis, an outer liner extending circumferentially about the combustor centerline axis, and an inner liner extending circumferentially about the combustor centerline axis, a combustion chamber being defined between the outer liner and the inner liner, an outer flow passage being defined between the outer casing and the outer liner, and an inner flow passage being defined between the inner casing and the inner liner, wherein at least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings.

The gas turbine engine according to the preceding clause, wherein a total primary dilution effective flow area of the plurality of primary dilution openings and a total secondary dilution effective flow area of the plurality of secondary wake suppression dilution openings define a total dilution effective flow area for dilution air, and a ratio of the total secondary dilution effective flow area to the total dilution effective flow area is in a range from five percent to forty percent.

The gas turbine engine according to any preceding clause, wherein the plurality of primary dilution openings are circumferentially spaced apart from one another, and the plurality of secondary wake suppression dilution openings are circumferentially spaced apart from one another.

The gas turbine engine according to any preceding clause, wherein each of the plurality of secondary wake suppression dilution openings is circumferentially offset from respective ones of the plurality of primary dilution openings.

The gas turbine engine according to any preceding clause, wherein each of the plurality of secondary wake suppression dilution openings is longitudinally offset, with respect to the combustor centerline axis, from the plurality of primary dilution openings.

The gas turbine engine according to any preceding clause, wherein each of the primary dilution openings is a circular-shaped dilution opening, and each of the plurality of secondary wake suppression dilution openings is a teardrop-shaped dilution opening.

The gas turbine engine according to any preceding clause, wherein each of the primary dilution openings is a circular-shaped dilution opening, and each of the plurality of secondary wake suppression dilution openings is a chevron-shaped dilution opening.

The gas turbine engine according to any preceding clause, wherein each of the primary dilution openings is a circular-shaped dilution opening, and each of the plurality of secondary wake suppression dilution openings is a diamond-shaped dilution opening.

The gas turbine engine according to any preceding clause, wherein each of the primary dilution openings is a circular-shaped dilution opening, and each of the plurality of secondary wake suppression dilution openings is an isosceles-trapezoid-shaped dilution opening.

The gas turbine engine according to any preceding clause, wherein each of the primary dilution openings is a circular-shaped dilution opening, and each of the plurality of secondary wake suppression dilution openings is a shield-shaped dilution opening.

The gas turbine engine according to any preceding clause, wherein each of the primary dilution openings is a circular-shaped dilution opening, and each of the plurality of secondary wake suppression dilution openings is a horn-shaped dilution opening.

The gas turbine engine according to any preceding clause, wherein each of the primary dilution openings is a semi-circular-shaped dilution opening, and each of the plurality of secondary wake suppression dilution openings is a wedge-shaped dilution opening, a rounded side of the semi-circular-shaped dilution opening being arranged on an upstream side of the primary dilution opening.

The gas turbine engine according to any preceding clause, wherein at least one of the plurality of primary dilution openings includes a wake flow suppressor arranged on a downstream edge of the semi-circular-shaped dilution opening, and extending into the combustion chamber.

The gas turbine engine according to any preceding clause, wherein the wake flow suppressor is a semi-oval-dome-shaped wake flow suppressor, and an upstream side of the wake flow suppressor includes a concave surface extending from the downstream edge of semi-circular-shaped dilution opening into the combustion chamber.

The gas turbine engine according to any preceding clause, wherein the at least one of the outer liner or the inner liner further includes at least one secondary airflow opening extending therethrough downstream of the primary dilution opening and extending through the wake flow suppressor to provide a secondary airflow into the combustion chamber downstream of the primary dilution opening.

The gas turbine engine according to any preceding clause, wherein each of the primary dilution openings is a circular-shaped dilution opening, and each of the plurality of secondary wake suppression dilution openings is a wedge-shaped dilution opening.

The gas turbine engine according to any preceding clause, wherein at least one of the secondary wake suppression dilution openings is angled with respect to a longitudinal direction of the combustor centerline axis.

The gas turbine engine according to any preceding clause, wherein at least one of the plurality of primary dilution openings includes a wake flow suppressor arranged on a downstream side of the circular-shaped dilution opening, and extending into the combustion chamber.

The gas turbine engine according to any preceding clause, wherein the wake flow suppressor is semi-oval-dome shaped and an upstream surface of the wake flow suppressor includes a concave surface extending from the downstream side of circular-shaped dilution opening into the combustion chamber.

The gas turbine engine according to any preceding clause, wherein the upstream surface of the wake flow suppressor is angled to direct the flow of the primary dilution air in a downstream direction within the combustion chamber.

The gas turbine engine according to any preceding clause, wherein the primary dilution openings are oval-shaped openings.

The gas turbine engine according to any preceding clause, wherein the over-shaped dilution openings have a major axis and a minor axis with respect to the combustor centerline axis, and the major axis extends in a longitudinal direction with respect to the combustor centerline axis and the minor axis extends in a circumferential direction with respect to the combustor centerline axis.

The gas turbine engine according to any preceding clause, wherein the oval-shaped dilution openings have a major axis and a minor axis with respect to the combustor centerline axis, and the major axis extends in a circumferential direction with respect to the combustor centerline axis and the minor axis extends in a longitudinal direction with respect to the combustor centerline axis.

The gas turbine engine according to any preceding clause, wherein the oval-shaped dilution openings include a centroid arranged along a first reference plane and the secondary wake suppression dilution openings have a centroid arranged along a second reference plane downstream of the first reference plane.

The gas turbine engine according to any preceding clause, wherein the primary dilution openings are semi-circular shaped dilution openings having an arched portion and a straight portion.

The gas turbine engine according to any preceding clause, wherein the straight portion is an upstream edge of the semi-circular shaped dilution opening, and the upstream edge is arranged along a reference plane extending perpendicular to the combustor centerline axis.

The gas turbine engine according to any preceding clause, wherein the straight portion is an upstream edge of the semi-circular shaped dilution opening, and the upstream edge is arranged upstream of a reference plane extending perpendicular to the combustor centerline axis.

The gas turbine engine according to any preceding clause, wherein the straight portion is an upstream edge of the semi-circular shaped dilution opening, and the upstream edge is arranged downstream of a reference plane extending perpendicular to the combustor centerline axis.

The gas turbine engine according to any preceding clause, wherein the primary dilution opening includes a wake flow suppressor arranged downstream of the arched portion.

The gas turbine engine according to any preceding clause, wherein a centroid of each of the plurality of primary dilution openings is arranged along a reference plane extending perpendicular to the combustor centerline axis, and a centroid of each of the plurality of secondary wake suppression dilution openings is arranged upstream of the reference plane.

The gas turbine engine according to any preceding clause, wherein a respective one of the plurality of secondary wake suppression dilution openings is arranged upstream of a respective one of the plurality of primary dilution openings.

The gas turbine engine according to any preceding clause, wherein the centroid of the respective one of the plurality of secondary wake suppression dilution openings and the centroid of the respective one of plurality of primary dilution openings are longitudinally aligned with each other.

The gas turbine engine according to any preceding clause, wherein the centroid of the respective one of the plurality of secondary wake suppression dilution openings and the centroid of the respective one of plurality of primary dilution openings are longitudinally offset from each other.

The gas turbine engine according to any preceding clause, wherein each of the plurality of primary dilution openings includes a wake flow suppressor arranged along a downstream side of the primary dilution opening.

The gas turbine engine according to any preceding clause, wherein each of the plurality of primary dilution openings is angled through the combustor liner in an upstream direction at an upstream angle, and each of the secondary wake flow suppression dilution openings is angled in a downstream direction at a downstream angle.

The gas turbine engine according to any preceding clause, wherein each of the secondary wake suppression dilution openings is a wedge-shaped dilution opening, and an apex of the wedge-shaped dilution opening is arranged on an upstream side of the wedge-shaped dilution opening.

The gas turbine engine according to any preceding clause, wherein each of the secondary wake suppression dilution openings is a wedge-shaped dilution opening, and an apex of the wedge-shaped dilution opening is arranged on an downstream side of the wedge-shaped dilution opening.

Although the foregoing description is directed to some exemplary embodiments of the present disclosure, other variations and modifications will be apparent to those skilled in the art, and may be made without departing from the present disclosure. Moreover, features described in connection with one embodiment of the present disclosure may be used in conjunction with other embodiments, even if not explicitly stated above.

We claim:

1. A combustor for a gas turbine, the combustor comprising:
an outer casing and an inner casing, each extending circumferentially about a combustor centerline axis;
an outer liner extending circumferentially about the combustor centerline axis; and
an inner liner extending circumferentially about the combustor centerline axis, a combustion chamber being defined between the outer liner and the inner liner, an outer flow passage being defined between the outer casing and the outer liner, and an inner flow passage being defined between the inner casing and the inner liner,
wherein at least one of the outer liner or the inner liner includes (a) a plurality of primary dilution openings extending therethrough to provide a flow of primary dilution air into the combustion chamber, and (b) a plurality of secondary wake suppression dilution openings extending therethrough to provide a flow of secondary dilution air into the combustion chamber, respective ones of the plurality of secondary wake suppression dilution openings being arranged adjacent to respective ones of the primary dilution openings to provide the flow of the secondary dilution air to suppress a wake formed in the flow of the primary dilution air at a downstream side of the primary dilution openings.

2. The combustor according to claim 1, wherein a total primary dilution effective flow area of the plurality of primary dilution openings and a total secondary dilution effective flow area of the plurality of secondary wake suppression dilution openings define a total dilution effective flow area for dilution air, and a ratio of the total secondary dilution effective flow area to the total dilution effective flow area is in a range from five percent to forty percent.

3. The combustor according to claim 1, wherein at least one of the plurality of primary dilution openings includes a wake flow suppressor arranged on a downstream edge of the primary dilution opening, and extending into the combustion chamber.

4. The combustor according to claim 3, wherein the wake flow suppressor is a semi-oval-dome-shaped wake flow suppressor, and an upstream side of the wake flow suppressor includes a concave surface extending from the downstream edge of primary dilution opening into the combustion chamber.

5. The combustor according to claim 4, wherein the at least one of the outer liner or the inner liner further includes at least one secondary airflow opening extending therethrough downstream of the primary dilution opening and extending through the wake flow suppressor to provide a secondary airflow into the combustion chamber downstream of the primary dilution opening.

6. The combustor according to claim 1, wherein the plurality of primary dilution openings are circumferentially spaced apart from one another, and the plurality of secondary wake suppression dilution openings are circumferentially spaced apart from one another.

7. The combustor according to claim 6, wherein each of the plurality of secondary wake suppression dilution openings is circumferentially offset from respective ones of the plurality of primary dilution openings.

8. The combustor according to claim 7, wherein each of the plurality of secondary wake suppression dilution openings is longitudinally offset, with respect to the combustor centerline axis, from the plurality of primary dilution openings.

9. The combustor according to claim 8, wherein each of the primary dilution openings is a circular-shaped dilution opening, and each of the plurality of secondary wake suppression dilution openings is a teardrop-shaped dilution opening.

10. The combustor according to claim 8, wherein each of the primary dilution openings is a circular-shaped dilution opening, and each of the plurality of secondary wake suppression dilution openings is a chevron-shaped dilution opening.

11. The combustor according to claim 8, wherein each of the primary dilution openings is a circular-shaped dilution opening, and each of the plurality of secondary wake suppression dilution openings is a diamond-shaped dilution opening.

12. The combustor according to claim 8, wherein each of the primary dilution openings is a circular-shaped dilution opening, and each of the plurality of secondary wake suppression dilution openings is an isosceles-trapezoid-shaped dilution opening.

13. The combustor according to claim 8, wherein each of the primary dilution openings is a circular-shaped dilution opening, and each of the plurality of secondary wake suppression dilution openings is a shield-shaped dilution opening.

14. The combustor according to claim 8, wherein each of the primary dilution openings is a circular-shaped dilution opening, and each of the plurality of secondary wake suppression dilution openings is a horn-shaped dilution opening.

15. The combustor according to claim 8, wherein each of the primary dilution openings is a semi-circular-shaped dilution opening, and each of the plurality of secondary wake suppression dilution openings is a wedge-shaped dilution opening, a rounded side of the semi-circular-shaped dilution opening being arranged on an upstream side of the primary dilution opening.

16. The combustor according to claim 8, wherein each of the primary dilution openings is a circular-shaped dilution opening, and each of the plurality of secondary wake suppression dilution openings is a wedge-shaped dilution opening.

17. The combustor according to claim 16, wherein at least one of the secondary wake suppression dilution openings is angled with respect to a longitudinal direction of the combustor centerline axis.

18. The combustor according to claim 16, wherein at least one of the plurality of primary dilution openings includes a wake flow suppressor arranged on a downstream side of the circular-shaped dilution opening, and extending into the combustion chamber.

19. The combustor according to claim 18, wherein the wake flow suppressor is semi-oval-dome-shaped and an upstream surface of the wake flow suppressor includes a concave surface extending from the downstream side of circular-shaped dilution opening into the combustion chamber.

20. The combustor according to claim 19, wherein the upstream surface of the wake flow suppressor is angled to direct the flow of the primary dilution air in a downstream direction within the combustion chamber.
